(19) United States
(12) Patent Application Publication
(10) Pub. No.: US 2003/0230973 A1
(43) Pub. Date: Dec. 18, 2003

(54) [ORGANIC ELECTRO-LUMINESCENCE DEVICE AND FABRICATING METHOD THEREOF]

(76) Inventors: twTung-Sheng Cheng, Kaohsiung (TW); tYu-Kai Han, Yunlin (TW); Chien-Ming Chen, Nantou County (TW); Jerry Yen, Hsinchu (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(21) Appl. No.: 10/250,198

(22) Filed: Jun. 12, 2003

(30) Foreign Application Priority Data
Jun. 13, 2002 (TW) 91112874

(51) Int. Cl. H05B 33/00

(52) U.S. Cl. 313/504

(57) ABSTRACT

The present invention provides an organic electro-luminescence device and fabricating thereof. The organic electro-luminescence device comprises a substrate, an anode on said substrate, a light-emitting layer on said anode, a cathode on said light-emitting layer, and an ion-doping layer between said cathode and said light-emitting layer, wherein said ion doping layer is Alq3 doped.

### CROSS REFERENCE TO RELATED APPLICATIONS

This application claims the priority benefit of Taiwan application serial no. 91112874, filed on Jun. 13, 2002.

### BACKGROUND OF INVENTION

1. Field of the Invention

This invention generally relates to an organic electro-luminescence device (“OEL”) and fabricating method thereof, and more particularly to an organic electro-luminescence device (“OEL”) and fabricating method thereof having a low driving voltage.

2. Description of Related Art

LCD panel has been widely used because of its lightweight and high efficiency. However, there are still some drawbacks of the LCD panel such as limited viewing angle, slow response speed and the need to be illuminated. More important, it is difficult to fabricate big size LCD panels.

A new flat panel technology, organic electro-luminescence technology, has been proposed and developed to solve the above issues. An organic electro-luminescence device uses the self-light-emitting feature of organic light emitting materials to perform the display. An organic electro-luminescence device comprises a pair of electrodes and a light-emitting layer, wherein the light-emitting layer includes light-emitting material. When the current goes through the transparent anode and the metal cathode, the holes and electrons interact to generate excitons so that the light-emitting material emits the light.

There are two types of the organic electro-luminescence device including the organic light emitting diode (“OLED”) device and the polymer light emitting diode (“PLED”) device. These two types operate essentially the same way. The only difference is that OLED uses small molecule organic material to form the light-emitting layer. The polymer material, with its larger molecular structure, is used to form the light-emitting layer for PLED.

FIG. 1 is the cross-sectional view of a conventional organic electro-luminescence device. The conventional organic electro-luminescence device includes a substrate 100, an anode 102 on the substrate 100, a, light-emitting layer 104 on the anode 102, and a cathode 106 on the light-emitting layer 104. Furthermore, a cap 110 is set above the cathode 106; a sealant 108 is set along the surrounding of the cap 110 and the substrate 100 to cover the organic electro-luminescence device.

The widely used material of the cathode 106 is a LiF/Al, Ba/Al, or Mg/Ag double-layer conducting layer, wherein Ba/Al is the most common material for the cathode 106. The portion of the double-layer conducting layer connecting with the light-emitting layer 104 has to have low work function in order to enhance the efficiency of the injection. For example, the work function of Ba in Ba/Al double-layer conducting layer has a low work function (2.7 eV.) Furthermore, to prevent the cathode from oxidation due to oxygen or H₂O, the metal of the outer layer of the cathode has to have a high work function characteristic. For example, the work function of Al in Ba/Al double-layer conducting layer has a high work function (4.28 eV.).

In the conventional organic electro-luminescence device, the thickness of low work function Ba must be larger than 50Ã□However, because of the limitation of semiconductor manufacturing process, it has to take at least two plating steps to form a Ba layer of 3000Ã□thickness. Hence, the conventional process for forming the cathode is complicated and expensive. Furthermore, because Ba is very easy to be oxidized, the process is very dangerous and is difficult to control its purity. Hence, this process for forming the cathode is not suitable for PLED device mass production.

### SUMMARY OF INVENTION

An object of the present invention is to provide an organic electro-luminescence device and fabricating method thereof to avoid the danger of the conventional process for forming the cathode.

Another object of the present invention is to provide an organic electro-luminescence device and fabricating method thereof to simplify the process complexity and save time.

The present invention provides an organic electro-luminescence device, comprising: a substrate; an anode on the substrate; a light-emitting layer on the anode; a cathode on the light-emitting layer; and an ion-doping layer between the cathode and the light-emitting layer, wherein the ion doping layer is Alq3 doped with a material selected from 0.1%-10% of LiClO₄ and other Li-like ion compounds such as Na, K, and Cs ion compounds. The light-emitting layer material can be polymer light-emitting material or organic light-emitting material. The cathode can be a single-layer conducting layer such as Al and Ag having high work function. The cathode also can be a double-layer conducting layer such as LiF/AI, Ba/Al, and Mg/Ag. The ion-doping layer has a thickness of 100 Ã□. 5000 Ã□and preferably 100 Ã□. 2000 Ã□

The present invention provides a method of fabricating an organic electro-luminescence device, comprising: forming an anode on a substrate; forming a light-emitting layer on the anode; forming an ion-doping layer on the light-emitting layer, wherein the ion doping layer is Alq3 doped with a material selected from 0.1%-10% of LiClO₄ and other Li-like ion compounds such as Na, K, and Cs ion compounds; and forming a cathode on the ion-doping layer. The ion-doping layer has a thickness of 50 Ã□. 5000 Ã□and preferably 50 Ã□. 2000 Ã□ The cathode can be a single-layer conducting layer such as Al and Ag having high work function. The cathode also can be a double-layer conducting layer such as LiF/AI, Ba/Al, and Mg/Ag.

The organic electro-luminescence device and fabricating method thereof of the present invention avoids the danger when using metal having a low work function to form the cathode so that it can improve the mass production process of forming the cathode and save time.

The organic electro-luminescence device and fabricating method thereof of the present invention improves the interface barrier between the metallic cathode and the light-emitting layer to increase the current density of the device.

The organic electro-luminescence device and fabricating method thereof of the present invention enhances the stability of the light-emitting layer of mass production.

The above is a brief description of some deficiencies in the prior art and advantages of the present invention. Other features, advantages and embodiments of the invention will be apparent to those skilled in the art from the following description, accompanying drawings and appended claims.

### BRIEF DESCRIPTION OF DRAWINGS

FIG. 1 is the cross-sectional view of a conventional organic electro-luminescence device.

FIG. 2 is the cross-sectional view of a preferred embodiment of an organic electro-luminescence device in accordance with the present invention.

FIG. 3 is the cross-sectional view of another preferred embodiment of an organic electro-luminescence device in accordance with the present invention.

FIG. 4 is the cross-sectional view of another preferred embodiment of an organic electro-luminescence device in accordance with the present invention.

FIG. 5 is the cross-sectional view of another preferred embodiment of an organic electro-luminescence device in accordance with the present invention.

FIG. 6 is the cross-sectional view of another preferred embodiment of an organic electro-luminescence device in accordance with the present invention.

FIG. 7 is the cross-sectional view of another preferred embodiment of an organic electro-luminescence device in accordance with the present invention.

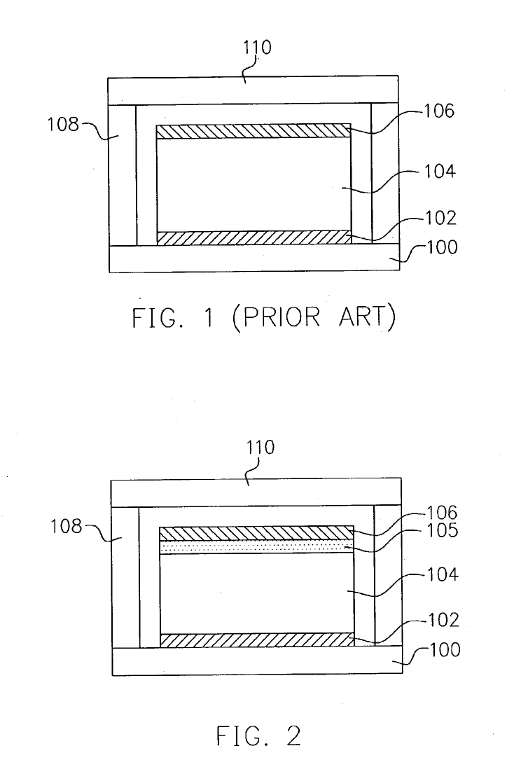

### DETAILED DESCRIPTION

FIG. 2 is the cross-sectional view of a preferred embodiment of an organic electro-luminescence device in accordance with the present invention.

Referring to FIG. 2, the organic electro-luminescence device is an double-layer structure comprising a transparent substrate 100, an anode 102, a light-emitting layer 104, an ion-doping layer 105, a cathode 106, a cap 110, and a sealant 108. The method of fabricating the organic electro-luminescence device comprises the steps of: forming the anode 102 on the transparent substrate 100; forming the light-emitting layer 104 on the anode 102; forming the ion-doping layer 105 on the light-emitting layer 104; forming the cathode 106 on the ion-doping layer 105; forming the cap 110 above the cathode 106; and forming the sealant 108 along the surrounding of the cap 110 and the substrate 100 to cover the organic electro-luminescence device.

The transparent substrate 100 is a glass substrate, a plastic substrate or a flexible substrate.

The anode 102 is set on the transparent substrate 100, and injects electrons into the light-emitting layer 104. Hence, the preferred anode the material having a work function higher than 4.5 eV such as ITO, TiO₂, Au, Ag, Pt, or Cu. The thickness of the anode is about 500 Ã□. 5000 Ã□

The light-emitting layer 104 is set on the anode 102, wherein the light-emitting layer can be polymer light-emitting material or organic light-emitting material. Poly phenylene vinylene (PVV) and polyfulerene (PF) are two examples of polymer light-emitting materials. The light-emitting layer is formed by spin-coating. The thickness of the light-emitting layer 104 is about 500 Ã□. 5000 Ã□The color characteristics of the light-emitting material depend on the energy gap between the ground state and the excited state of the material.

The cathode 106 is set on the light-emitting layer 104 to inject the electrons into the light-emitting layer 104. The cathode 106 can be a single-layer conducting layer such as Al and Ag having high work function. The cathode also can be a double-layer conducting layer such as LiF/AI, Ba/Al, and Mg/Ag. The cathode is formed by evaporation and has a thickness of 500 Ã□. 5000 Ã□

To make the cathode more efficiently inject the electrons into the light-emitting layer 104 and avoid the danger of the process, the organic electro-luminescence device of present invention has an ion-doping layer 105 between the cathode 106 and the light-emitting layer 104. The ion-doping layer 105 is Alq3 doped with a material selected from 0.1%-10% of LiClO₄ and other Li-like ion compounds such as Na, K, and Cs ion compounds. The ion-doping layer is formed by evaporation and has a thickness of 500 Ã□. 5000 Ã□and preferably 50 Ã□. 2000 Ã□

Because the ion-doping layer is a non-hyperresponsive material and has a low work function, if the ion-doping layer is formed on the surface of the metal having a high low function (e.g., Al), it can enhance the efficiency of the electron injection and can avoid the danger in the conventional method of fabricating an organic electro-luminescence device due to the oxidation-reduction reaction between the metal having a low work function (e.g., Ba) and the air. Hence, the present invention can improve the manufacturing process of forming the cathode to avoid the danger when using metal having a low work function, and is suitable for monochromic or full-color ink jet printing processes for the mass production of organic electro-luminescence devices. Furthermore, because the ion-doping layer is thinner, the present invention also reduces the process time.

Moreover, in the present invention, the ion-doping layer 106 can also be formed on the surface of the double-conducting-layer cathode 106 so that the ion-doping layer 105 can cover the metal having a low work function (e.g., Ba). This alternative also avoids the danger in the conventional method of fabricating an organic electro-luminescence device due to the oxidation-reduction reaction between the metal having a low work function (e.g., Ba) and the air.

It should be noted that the ion-doping layer 106 could improve the interface barrier between the metallic cathode 106 and the light-layer 104 in order to increase the current density of the device. Furthermore, the light-emitting layer is more stable after the thermal treatment process or electric burn-in process of the organic electro-luminescence device.

The cap 110 is set above the cathode 106; the sealant 108 is set along the surrounding of the substrate 100 and the cap 110 to cover the electro-luminescence device.

In the present invention, the current applied to the electro-luminescence device is usually a DC, but it also can be a pulse current or an AC. Furthermore, electro-luminescence device can emit the light by transmitting from the anode 102 or reflecting from the cathode 106.

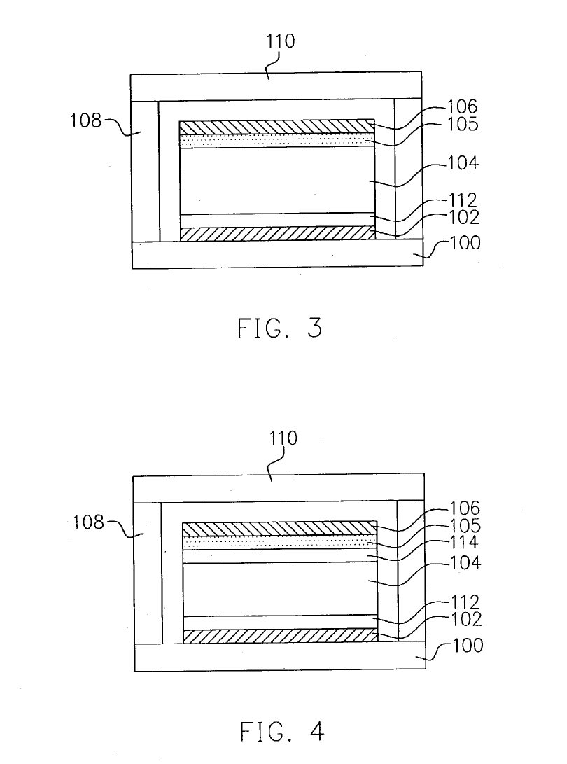

The electro-luminescence device also can be a three-layer structure device as shown in FIG. 3. Compared to FIG. 2, this device further comprises a hole-transmitting layer 112 between the light-emitting layer 104 and the anode 102.

The electro-luminescence device also can be a four-layer structure device as shown in FIG. 4. Compared to FIG. 2, this device further comprises a hole-transmitting layer 112 between the light-emitting layer 104 and the anode 102 and an electron-transmitting layer 114 between the light-emitting layer 104 and the ion-doping layer 105. There is also another four-layer structure device, wherein an electron-transmitting layer 114 is between the light-emitting layer 104 and the anode 102 and a hole-injecting layer 112a between the light-emitting layer 104 and the anode 102.

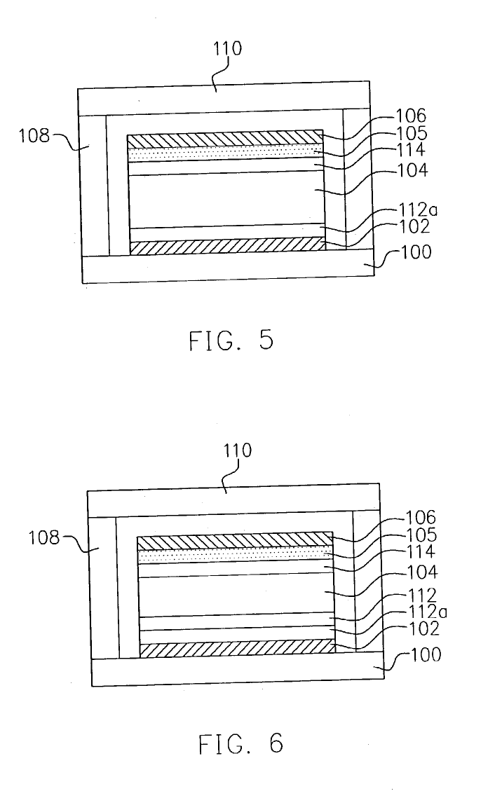

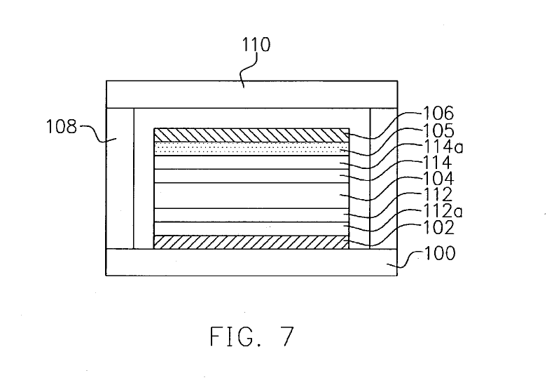

The electro-luminescence device also can be a five-layer structure device as shown in FIG. 5. Compared to FIG. 4, this five-layer structure device further comprises a hole-injecting layer 112a between the hole-transmitting layer 112 and the anode 102.

The electro-luminescence device also can be a six-layer structure device as shown in FIG. 6. Compared to FIG. 5, this five-layer structure device further comprises an electron-injecting layer 114a between the electron-transmitting layer 114 and the light-emitting layer 104.

The hole-transmitting layer 112, the electron-transmitting layer 114, the hole-injecting layer 112a, and the electron-injecting layer 114a are formed by spin coating. Furthermore, the material of the hole-transmitting layer 112 can be poly ethylene dioxythisophene (“PEDOT”) or polyaniline (“PANi”). The thickness of the hole-transmitting layer 112 is around 500 Ã□. 2500 Ã□

Accordingly, the present invention has the following advantages.

1. The electro-luminescence device of the present invention can improve the manufacturing process of forming the cathode to avoid the danger when using metal having a low work function, and is suitable for monochromic or full-color ink jet printing processes for the mass production of organic electro-luminescence devices.

2. The electro-luminescence device of the present invention can save the fabrication time.

3. The electro-luminescence device of the present invention can improve the interface barrier between the metallic cathode and the light-emitting layer in order to increase the current density of the device.

4. The light-emitting layer is more stable after the thermal treatment process or electric burn-in process of the organic electro-luminescence device of the present invention.

The above description provides a full and complete description of the preferred embodiments of the present invention. Various modifications, alternate construction, and equivalent may be made by those skilled in the art without changing the scope or spirit of the invention. Accordingly, the above description and illustrations should not be construed as limiting the scope of the invention which is defined by the following claims.

1. An organic electro-luminescence device, comprising:
a substrate;
an anode on said substrate;
a light-emitting layer on said anode;
a cathode on said light-emitting layer; and
an ion-doping layer between said cathode and said light-emitting layer, wherein said ion doping layer is Alq3 doped with a material selected from 0.1%-10% of LiClO₄ and other Li-like ion compounds.

2. The organic electro-luminescence device of claim 1, wherein said Li-like ion compounds include Na, K, and Cs ion compounds.

3. The organic electro-luminescence device of claim 1, wherein said cathode is a single-layer conducting layer and the material of said single-layer conducting layer is selected from Al and Ag.

4. The organic electro-luminescence device of claim 1, wherein said ion-doping layer is a double-layer conducting layer and the material of said double-layer conducting layer is selected from LiF/AI, Ba/Al, and Mg/Ag.

5. The organic electro-luminescence device of claim 1, wherein said ion-doping layer has a thickness of 50 Ã□. 5000 Ã□

6. The organic electro-luminescence device of claim 1, wherein said ion-doping layer has a thickness of 50 Ã□. 2000 Ã□

7. The organic electro-luminescence device of claim 1, further comprising a hole-transmitting layer between said anode and said light-emitting layer.

8. The organic electro-luminescence device of claim 1, further comprising an electron-transmitting layer between said ion-doping layer and said light-emitting layer.

9. The organic electro-luminescence device of claim 1, further comprising a hole-injecting layer between said light-emitting layer and said anode.

10. The organic electro-luminescence device of claim 1, further comprising an electron-injecting layer between said ion-doping layer and said light-emitting layer.

11. The organic electro-luminescence device of claim 1, further comprising:
a cap on said cathode; and
a sealant set along the surrounding of said cap and said substrate to cover said organic electro-luminescence device.

12. A method of fabricating an organic electro-luminescence device, comprising:
forming an anode on a substrate;
forming a light-emitting layer on said anode;
forming an ion-doping layer on said light-emitting layer,
wherein said ion doping layer is Alq3 doped with a material selected from 0.1%-10% of LiClO₄ and other Li-like ion compounds; and
forming a cathode on said ion-doping layer.

13. The method of fabricating an organic electro-luminescence device of claim 12, wherein said Li-like ion compounds includes Na, K, and Cs ion compounds.

14. The method of fabricating an organic electro-luminescence device of claim 12, wherein said cathode is a single-layer conducting layer and the material of said single-layer conducting layer is selected from Al and Ag.

15. The method of fabricating an organic electro-luminescence device of claim 12, wherein said ion-doping layer is a double-layer conducting layer and the material of said double-layer conducting layer is selected from LiF/AI, Ba/Al, and Mg/Ag.

16. The method of fabricating an organic electro-luminescence device of claim 12, wherein said ion-doping layer has a thickness of 50 Ã□. 5000 Ã□

17. The method of fabricating an organic electro-luminescence device of claim 12, wherein said ion-doping layer has a thickness of 50 Ã□. 2000 Ã□

18. The method of fabricating an organic electro-luminescence device of claim 12, further comprising forming a hole-transmitting layer between said anode and said light-emitting layer.

19. The method of fabricating an organic electro-luminescence device of claim 12, further comprising forming an electron-transmitting layer between said ion-doping layer and said light-emitting layer.

20. The method of fabricating an organic electro-luminescence device of claim 12, further comprising forming a hole-injecting layer between said light-emitting layer and said anode.

21. The method of fabricating an organic electro-luminescence device of claim 12, further comprising forming an electron-injecting layer between said ion-doping layer and said light-emitting layer.

22. The method of fabricating an organic electro-luminescence device of claim 12, further comprising
forming a cap above said cathode; and
forming a sealant along the surrounding of said cap and said substrate to cover said organic electro-luminescence device.

23. The method of fabricating an organic electro-luminescence device of claim 12, wherein said ion-doping layer is formed by evaporation.

24. A polymer light emitting diode device, comprising:
a substrate;
an anode on said substrate;
a polymer light-emitting layer on said anode;
a cathode on said light-emitting layer; and
an ion-doping layer between said cathode and said light-emitting layer, wherein said ion doping layer is Alq3 doped with a material selected from 0.1%-10% of LiClO₄ and other Li-like ion compounds.

25. The polymer light emitting diode device of claim 24, wherein said Li-like ion compounds includes Na, K, and Cs ion compounds.

26. The polymer light emitting diode device of claim 24, wherein said cathode is a single-layer conducting layer and the material of said single-layer conducting layer is selected from Al and Ag.

27. The polymer light emitting diode device of claim 24, wherein said ion-doping layer is a double-layer conducting layer and the material of said double-layer conducting layer is selected from LiF/AI, Ba/Al, and Mg/Ag.

28. The polymer light emitting diode device of claim 24, wherein said ion-doping layer has a thickness of 50 Ã□. 5000 Ã□

29. The polymer light emitting diode device of claim 24, wherein said ion-doping layer has a thickness of 50 Ã□. 2000 Ã□

30. The polymer light emitting diode device of claim 24, wherein said polymer light-emitting layer material is selected from PVV and PF.

31. The polymer light emitting diode device of claim 24, further comprising a hole-transmitting layer between said anode and said polymer light-emitting layer.

32. The polymer light emitting diode device of claim 24, wherein said hole-transmitting layer material is selected from PEDOT and PANi, and has a thickness of 500 Ã□. 2500 Ã□

33. The polymer light emitting diode device of claim 24, further comprising an electron-transmitting layer between said ion-doping layer and said polymer light-emitting layer.

34. The polymer light emitting diode device of claim 24, further comprising a hole-injecting layer between said polymer light-emitting layer and said anode.

35. The polymer light emitting diode device of claim 24, further comprising an electron-injecting layer between said ion-doping layer and said polymer light-emitting layer.

36. The polymer light emitting diode device of claim 24, further comprising:
a cap on said cathode; and
a sealant set along the surrounding of said cap and said substrate to cover said polymer light emitting diode device.

37. An organic light emitting diode device, comprising:
a substrate;
an anode on said substrate;
an organic light-emitting layer on said anode;
a cathode on said light-emitting layer; and
an ion-doping layer between said cathode and said light-emitting layer, wherein said ion doping layer is Alq3 doped with a material selected from 0.1%-10% of LiClO₄ and other Li-like ion compounds.

38. The organic light emitting diode device of claim 37, wherein said Li-like ion compounds includes Na, K, and Cs ion compounds.

39. The organic light emitting diode device of claim 37, wherein said cathode is a single-layer conducting layer and the material of said single-layer conducting layer is selected from Al and Ag.

40. The organic light emitting diode device of claim 37, wherein said ion-doping layer is a double-layer conducting layer and the material of said double-layer conducting layer is selected from LiF/AI, Ba/Al, and Mg/Ag.

41. The organic light emitting diode device of claim 37, wherein said ion-doping layer has a thickness of 50 Ã□. 5000 Ã□

42. The organic light emitting diode device of claim 37, wherein said ion-doping layer has a thickness of 50 Ã□. 2000 Ã□

43. The organic light emitting diode device e of claim 37, further comprising a hole-transmitting layer between said anode and said organic light-emitting layer.

44. The organic light emitting diode device of claim 37, further comprising an electron-transmitting layer between said ion-doping layer and said organic light-emitting layer.

45. The organic light emitting diode device of claim 37, further comprising a hole-injecting layer between said organic light-emitting layer and said anode.

46. The organic light emitting diode device of claim 37, further comprising an electron-injecting layer between said ion-doping layer and said organic light-emitting layer.

47. The organic light emitting diode device of claim 37, further comprising:
a cap on said cathode; and
a sealant set along the surrounding of said cap and said substrate to cover said organic light emitting diode device.
